(19) United States
(12) Patent Application Publication
(10) Pub. No.: US 2018/0185234 A1
(43) Pub. Date: Jul. 5, 2018

(54) CHAIR MASSAGER AND MASSAGING MECHANISM

(71) Applicant: DAITO ELECTRIC MACHINE INDUSTRY COMPANY LIMITED, Higashi-Osaka-shi, Osaka (JP)

(72) Inventors: Fumitaka ISHIGURO, Higashi-Osaka-shi (JP); Mikitaka AOKI, Higashi-Osaka-shi (JP); Yasushi SONE, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 15/513,782

(22) PCT Filed: Apr. 27, 2016
(86) PCT No.: PCT/JP2016/063229

§ 371 Date: Mar. 23, 2017

(30) Foreign Application Priority Data
Jul. 3, 2015 (JP) 2015-134483
Apr. 26, 2016 (JP) 2016-088110

(51) Int. Cl. A61H 7/00; A47C 7/44; A61H 15/00

(52) U.S. Cl. CPC A61H 7/007; A61H 7/004; A47C 7/441; A61H 2015/0042; A61H 2201/0149; A61H 2201/1669; A61H 2201/1623; A61H 15/0078

(57) ABSTRACT

Good massage can be performed on a wide range of user's body, extending from the shoulder to the buttocks.

A chair massager (1) comprises a massaging mechanism (7) having a massager piece for massaging part of user's body as a target of massage, and a moving rail (8) disposed along a vertical direction to guide the massaging mechanism (7) in vertical movement. The massager piece includes a first massager piece (14) lying in an upper position as seen from the massaging mechanism (7), and a second massager piece (15) lying in a lower position as seen from the massaging mechanism (7). The massaging mechanism (7) is designed to perform massage by actuating the second massager piece (15) to jut toward the target of massage when set in position at the bottom part of the moving rail (8).

### TECHNICAL FIELD

The present invention relates to a chair massager capable of massaging a wide range of the body, extending from the shoulder to the buttocks, of a user sitting in a seat of the chair massager. Moreover, the present invention relates to a massaging mechanism which holds a body area to be massaged in sandwich relation and performs grabbing massage on the target body area.

### BACKGROUND ART

There is a heretofore known chair massager comprising a seat in which a user sits, and a backrest for supporting the back of the user sitting in the seat. The backrest of the chair massager is internally provided with a massaging mechanism for massaging targets of massage, such as user's shoulder, back, and waist by mechanical means, and a moving rail for enabling the massaging mechanism to move in a top-bottom, or vertical direction. That is, in the conventional chair massager, massage on each target of massage, namely user's shoulder, back, and waist is performed on an individual basis by moving the massaging mechanism in the vertical direction along the moving rail to adjust a massager piece disposed in the massaging mechanism to a corresponding vertical position.

For example, Patent Literature 1 discloses a chair massager having a massaging system called “massager mechanism” mounted inside a chair main body. The massaging system called “massager mechanism” disclosed in Patent Literature 1 is free to move up and down along a vertically extending rail in the interior of the backrest.

Moreover, Patent Literature 2 discloses a massaging apparatus having a rail for guiding a back massaging unit attached to a back frame of a backrest mounted at the rear of a seat. According to the description of Patent Literature 2, in the massaging apparatus, the back massaging unit is movable within the range of rail arrangement.

### PRIOR ART REFERENCE

### Citation List

Patent Literature 1: Japanese Unexamined Patent Publication JP-A 2015-9103

Patent Literature 2: Japanese Unexamined Patent Publication JP-A 2014-200445

### SUMMARY OF INVENTION

### Technical Problem

In recent years, there is an increasing demand for a chair massager capable of massaging not only the range of user's body extending from the shoulder to the waist, but also the buttocks. To meet such a demand, the massaging mechanism needs to be movable to a position near the buttocks. However, in general, the moving rail for moving the massaging mechanism is housed inside the backrest, wherefore the massaging mechanism cannot be moved to the buttocks.

For example, the moving rail as disclosed in each of Patent Literatures 1 and 2 terminates at a position inside the backrest and is hence not extended over a region under the seat. That is, the massaging mechanism cannot be moved to a position corresponding to user's buttocks, with consequent difficulties in performing massage on the buttocks.

The present invention has been devised in view of the problems as discussed supra, and accordingly an object of the present invention is to provide a chair massager capable of massaging a wide range of user's body extending from the shoulder to the buttocks.

Moreover, in recent years, there arise demands for a wider variety of massage effects, and more specifically, for example, there is a user's request asking a hand massage-like grabbing massage to be performed on his/her shoulders.

Accordingly, another object of the present invention is to provide a massaging mechanism which holds in sandwich relation a body area to be massaged between a grabbing massager piece and a massager piece disposed in face-to-face relation to the grabbing massager piece, and performs grabbing massage on the target body area.

### Solution to Problem

To accomplish the described objects, the following technical means is adopted for the implementation of the present invention.

A chair massager pursuant to the present invention comprises a massaging mechanism having a massager piece for massaging a body part of a user to be massaged as a target of massage, and a moving rail disposed along a vertical direction to guide the massaging mechanism in movement in the vertical direction. The massager piece includes a first massager piece lying in an upper position as seen from the massaging mechanism, and a second massager piece lying in a lower position as seen from the massaging mechanism. The massaging mechanism is designed to perform massage by actuating the second massager piece to jut toward the target of massage when set in position at a bottom part of the moving rail.

In the invention, it is preferable that the massaging mechanism is designed to perform massage by actuating the first massager piece to jut toward user's shoulder, while retracting the second massager piece, when set in position at a top part of the moving rail, as well as to perform massage by actuating the second massager piece to jut toward user's buttocks, while retracting the first massager piece, when set in position at the bottom part of the moving rail.

In the invention, it is preferable that there are provided a seat portion in which the user sits, and a backrest portion for supporting the back of the user sitting in the seat portion, that the top part of the moving rail is disposed inside the backrest portion so as to point in the vertical direction alongside a backrest surface of the backrest portion, that the bottom part of the moving rail is disposed alongside a seat surface of the seat portion, and that a lower end of the moving rail is situated below the seat portion.

In the invention, it is preferable that the massaging mechanism has a first arm and a second arm that extend upwardly and downwardly, respectively, as viewed from the massaging mechanism set in position at the top part of the moving rail, and that the first massager piece is attached to a tip of the first arm, and the second massager piece is attached to a tip of the second arm.

In the invention, it is preferable that the second arm is made relatively long compared to the first arm.

In the invention, it is preferable that the first massager piece is mounted for free rotation relative to the first arm, and, the first massager piece is brought into contact with the shoulder, with its axis of rotation directed in a direction intersected by the top part of the moving rail, and that the second massager piece is mounted for free rotation relative to the second arm, and, the second massager piece is brought into contact with the buttocks, with its axis of rotation directed in a direction which is substantially parallel to the bottom part of the moving rail.

In the invention, it is preferable that the first arm and the second arm are joined together at one and the same base end, and this base end is pivotally mounted for free rocking motion upon a rotary shaft whose axis is directed in a horizontal direction, that there is provided jutting-amount varying means for varying an amount of jutting motion of the first arm and the second arm facing toward the target of massage by rocking the base end of the first and second arms about the rotary shaft, that the jutting-amount varying means comprises: a guide, secured to a tapping drive section, having two restraining portions arranged in a predetermined spacing; a coupling shaft for coupling the base end of the first and second arms to the guide; and a slide which is smaller in length than the predetermined spacing in the guide, and is driven to move within a range of the spacing, that one of the restraining portions formed in the guide is defined as a first restraining portion, and the other is defined as a second restraining portion, and, the spacing between the first restraining portion and the second restraining portion serves as a non-restraining portion, that the first restraining portion of the jutting-amount varying means maintains a rocking angle of the first arm or the second arm for a fully jutting-out position of the first arm or the second arm, and, the second restraining portion of the jutting-amount varying means maintains a rocking angle of the second arm or the first arm for a fully jutting-out position of the second arm or the first arm, and that the non-restraining portion of the jutting-amount varying means permits axial rocking motion of the base end of the first and second arms within a range of the spacing between the first restraining portion and the second restraining portion.

In the invention, it is preferable that there are provided a grabbing massager piece which performs grabbing massage on the target of massage during its approaching and separating movements relative to the first massager piece, and a grabbing arm provided at its tip with the grabbing massager piece.

In the invention, it is preferable that, while the grabbing massager piece stays in proximity to the first massager piece, the first massager piece can be rocked in the horizontal direction.

In the invention, it is preferable that the second arm is made relatively long compared to the grabbing arm.

Moreover, a massaging mechanism pursuant to the present invention has the grabbing arm provided at its one side with the grabbing massager piece and the first arm provided at its tip with the first massager piece, and produces massaging action by actuating the grabbing arm and the first arm. The massaging mechanism is designed to actuate the grabbing arm so that the grabbing massager piece moves close to and away from the first massager piece.

In the invention, it is preferable that there are provided: an eccentric boss portion, mounted eccentrically with respect to the rotary shaft, having a cam face formed on its outer peripheral surface; an annular fit portion attached to the grabbing arm so as to engage with the cam face of the eccentric boss portion; and a restraint section for restraining the grabbing arm from rotating together with the rotary shaft in response to a rotation of the rotary shaft.

In the invention, it is preferable that the restraint section includes a restraint pin attached to the other side of the grabbing arm, and a restraint slot, located in face-to-face relation to the restraint pin, in which the restraint pin is slidably fitted.

In the invention, it is preferable that the restraint section includes a restraint slot formed in the other side of the grabbing arm, and a restraint pin, located in face-to-face relation to the restraint slot, which fits in the restraint slot for free sliding movement.

In the invention, it is preferable that the first arm is provided at its tip with the first massager piece, and, the rotary shaft is disposed so as to pass through an intermediate part or the base end of the first arm, and that the first arm is driven to rock in the horizontal direction under a driving force exerted by the rotary shaft.

### Advantageous Effects of Invention

The chair massager pursuant to the present invention is capable of massaging a wide range of user's body extending from the shoulder to the buttocks. Moreover, the massaging mechanism pursuant to the present invention holds in sandwich relation a body area to be massaged between the grabbing massager piece and a massager piece disposed in face-to-face relation to the grabbing massager piece, and performs grabbing massage on the target body area.

### BRIEF DESCRIPTION OF DRAWINGS

FIG. 1 is a perspective view of a chair massager in accordance with a present embodiment.

FIG. 2 is a side view showing the internal structure of the chair massager in which a massaging mechanism is set in position at the top part of a moving rail.

FIG. 3 is a perspective view showing the internal structure of a backrest portion in which the massaging mechanism is set in position at the top part of the moving rail.

FIG. 4A is a side view (left-hand side view) of the massaging mechanism set in position at the top part of the moving rail.

FIG. 4B is a side view (left-hand side view) of the massaging mechanism set in position at an intermediate part of the moving rail in a vertical direction (corresponding to a waist massage range).

FIG. 4C is a side view (left-hand side view) of the massaging mechanism set in position at the bottom part of the moving rail, with its first massager piece jutted out.

FIG. 4D is a side view (left-hand side view) of the massaging mechanism set in position at the bottom part of the moving rail, with its second massager piece jutted out.

FIG. 5 is a view showing the internal structure of the massaging mechanism as seen from behind.

FIG. 6 is a view showing the internal structure of the massaging mechanism as seen from in front.

FIG. 7 is a view showing the internal structure of the massaging mechanism as seen from the side (right side).

FIG. 8 is a side view (right-hand side view) of the massaging mechanism, with its first massager piece jutted out.

FIG. 9 is a side view (right-hand side view) of the massaging mechanism, with its second massager piece jutted out.

### DESCRIPTION OF EMBODIMENTS

Hereinafter, a chair massager 1 pursuant to the present invention will be described with reference to drawings.

The chair massager 1 in accordance with the first embodiment looks like a chair in which a user is able to sit.

The chair massager 1 comprises a seat portion 2 in which a user sits; a backrest portion 3 against which the user sitting in the seat portion 2 leans; and an armrest portion 4 for supporting each elbow of the user sitting in the seat portion 2. Moreover, the chair massager 1 is provided with a footrest portion 5 for massaging user's legs that can be housed in a space under the seat portion 2.

The following describes the seat portion 2, the backrest portion 3, the armrest portion 4, and the footrest portion 5 that constitute the chair massager 1.

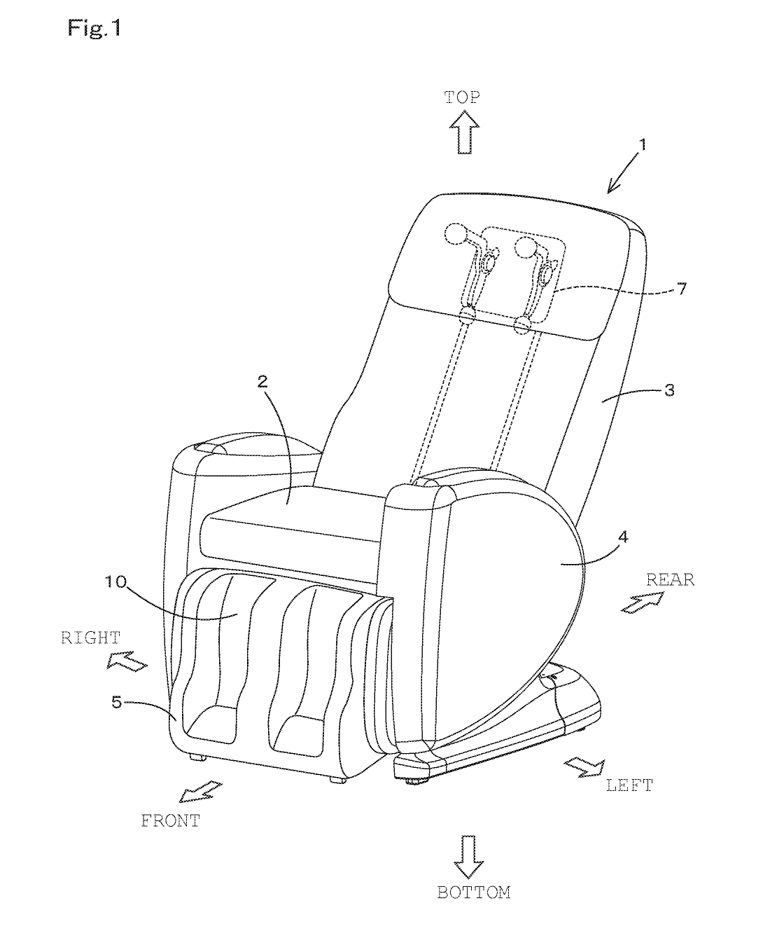

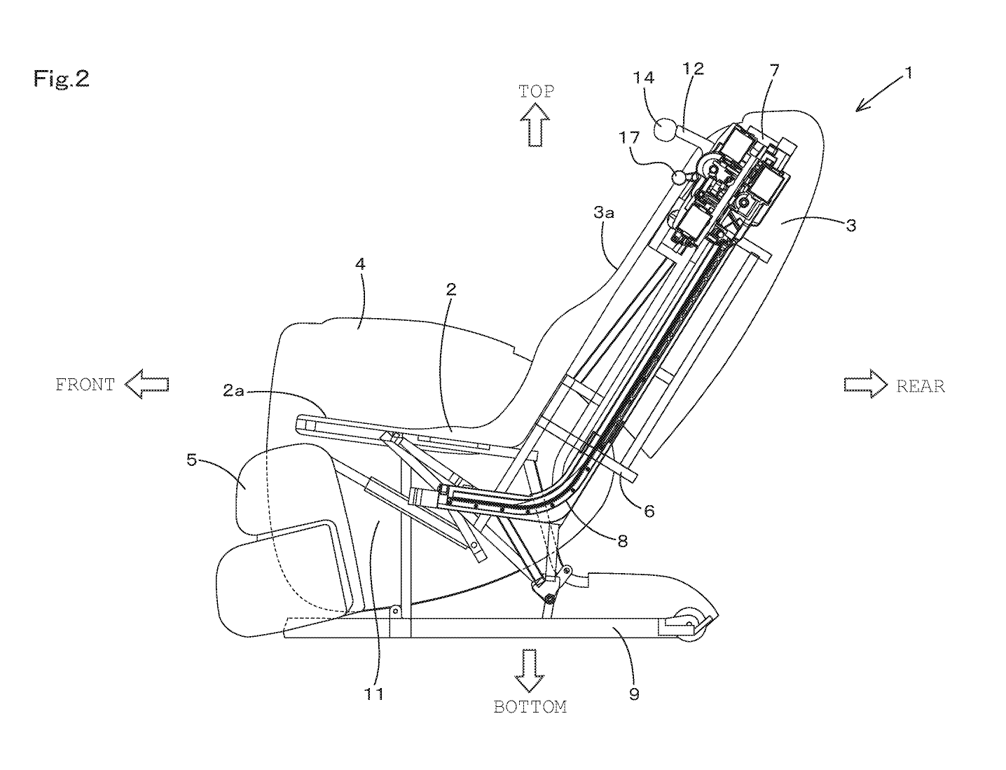

In what follows, the chair massager 1 will be described on the basis of directions indicated by arrows in FIGS. 1 and 2. These directions coincide with those based on the view of the user sitting in the chair massager 1. Each direction is indicated by corresponding one of the arrows shown in FIGS. 1 and 2.

As shown in FIGS. 1 and 2, the seat portion 2 is a flat member extending horizontally (extending both in a front-rear direction and in a right-left, or horizontal direction). A cushioning material is disposed on the top of the seat portion 2 to provide a comfortable seating for a user.

Under the seat portion 2 is disposed a support frame 6 via which the seat portion 2 is supported on a floor, for example. The support frame 6 is composed of rectangular bars (rodlike members) oriented in vertical, horizontal, and front-rear directions combined into a lattice-work form, for retaining the seat portion 2 in a position spaced upwardly from the floor.

The backrest portion 3 is a member disposed at the rear of the seat portion 2. As with the seat portion 2, a cushioning material is used to form that side of the backrest portion 3 which faces the user. Moreover, the backrest portion 3 incorporates a massaging mechanism 7 for massaging (performing massage operation on) targets of massage, such as the shoulder, the back, the waist, and the buttocks of the sitting user, and a moving rail 8 disposed along the vertical direction, for guiding the described massaging mechanism 7 in vertical movement.

A support frame 6 provided in the backrest portion 3 and the support frame 6 of the seat portion 2 are fixedly coupled to each other in a single-piece structure. This support frame 6 assembly protrudes downwardly, and the lower end of the protrusion is pivotally mounted upon a floor-mounted frame 9 (a frame body placed on a floor, for example) for free rocking motion about an axis directed in the horizontal direction. That is, the seat portion 2 and the backrest portion 3 are designed to move unitarily back and forth about the horizontally-directed axis for assuming a reclining position.

The armrest portion 4 is composed of a left armrest 4 mounted on the left side of the seat portion 2 and a right armrest 4 mounted on the right side of the seat portion 2. The upper surface of each of the right and left armrests 4 is shaped as a flat face elongated in the front-rear direction, wherefore the user is able to rest his/her elbow or arm on it.

A space left under the seat portion 2 and between the right and left armrests 4 constitutes a housing chamber 11 in which is housed the footrest portion 5. More specifically, the footrest portion 5 is a rectangular member having a leg insertion recess 10 opening into the front part and upper part thereof, for insertion of user's leg. Moreover, the footrest portion 5 has a built-in leg massaging section for massaging user's leg inserted in the leg insertion recess 10, for performing massage on user's legs.

The massaging mechanism 7 disposed inside the backrest portion 3 has a massager piece for massaging part of user's body to be massaged as a target of massage, and is hence capable of massaging the target of massage by using the massager piece. Moreover, since the massaging mechanism 7 can be guided in vertical movement along the described moving rail 8, it is possible to adjust the massager piece to a vertical position corresponding to each of the shoulder, the back, the waist, etc. of the user, and thereby perform massage on each target of massage on an individual basis.

More specifically, the massaging mechanism 7 has a first arm 12 and a second arm 13 that are disposed so as to extend forwardly and upwardly, and forwardly and downwardly, respectively, as viewed from the massaging mechanism 7. A first massager piece 14 is attached to the tip of the first arm 12, and a second massager piece 15 is attached to the tip of the second arm 13.

Moreover, the massaging mechanism 7 has a grabbing arm 16 disposed between the first massager piece 14 and the second massager piece 15 so as to extend forwardly (toward a target of massage) from the massaging mechanism 7. The tip of the grabbing arm 16 is also provided with a grabbing massager piece 17 capable of performing grabbing massage on a target of massage. The massaging mechanism 7 has kneading massage means for performing kneading massage on a target of massage by using the first massager piece 14 and the second massager piece 15, and grabbing massage means for allowing a target of massage held in sandwich relation between the first massager piece 14 and the grabbing massager piece 17 to receive grabbing massage.

The kneading massage means and the grabbing massage means will hereafter be particularized.

The described massaging mechanism 7 is further provided with vertically moving means for moving the massaging mechanism 7 along the moving rail 8, and jutting-amount varying means for determining the choice of which one of the described two massager pieces to move toward a target area of user's body (to move forward). That is, in the chair massager 1 in this embodiment, the massaging mechanism 7 is moved to a position corresponding to a target of massage, such as the shoulder, the back, the waist, or the buttocks, by using the vertically moving means, and, one of the first massager piece 14 and the second massager piece 15 is brought into contact with the target area of user's body by using the jutting-amount varying means. This makes it possible to perform massage on each target of massage with high effectiveness.

The following describes the first arm 12 and the second arm 13 provided in the massaging mechanism 7, the moving rail 8 for guiding the massaging mechanism 7 in vertical movement, and the operation of the massaging mechanism 7 on a path defined by the moving rail 8.

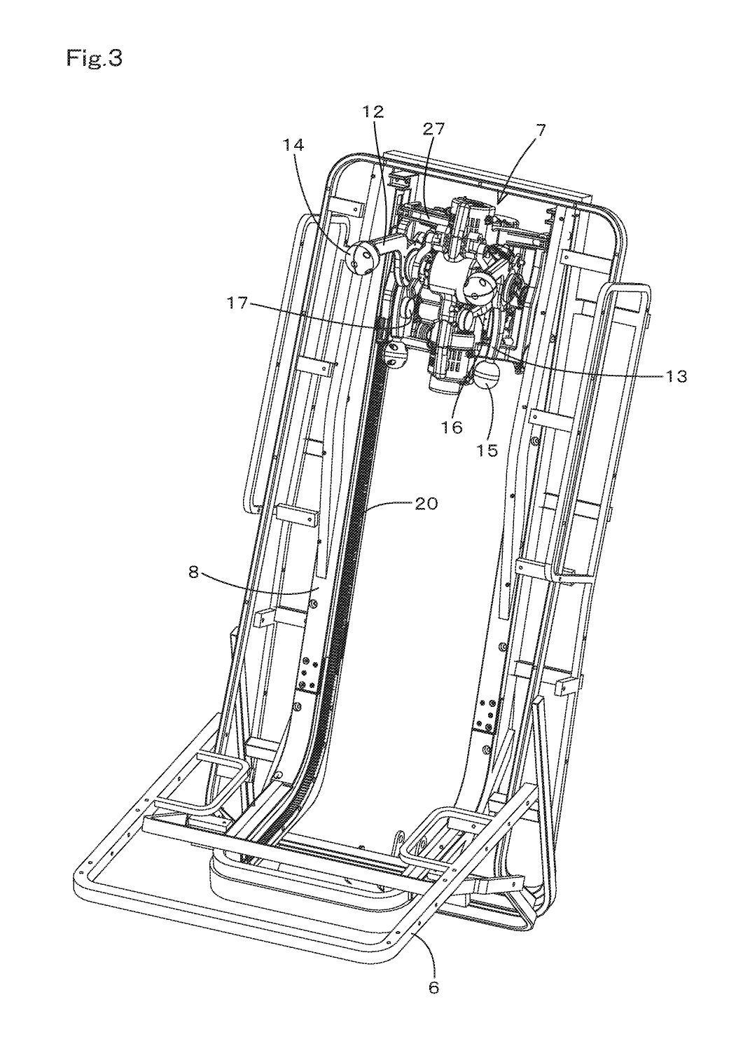

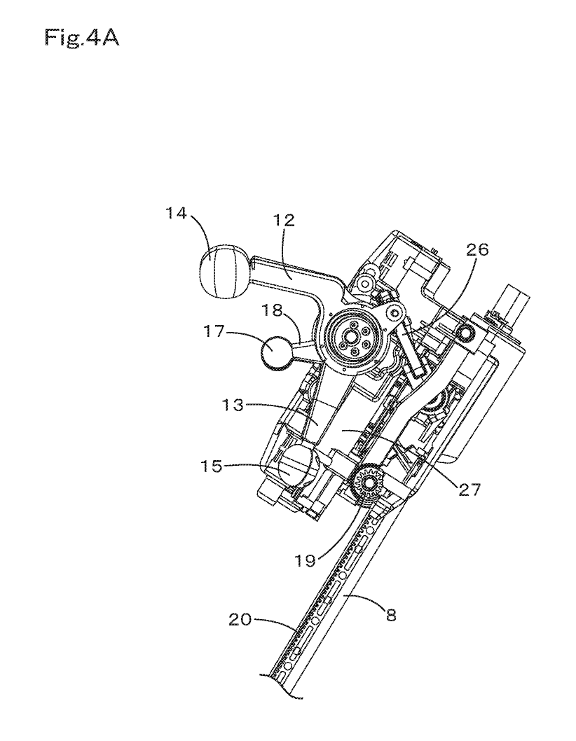

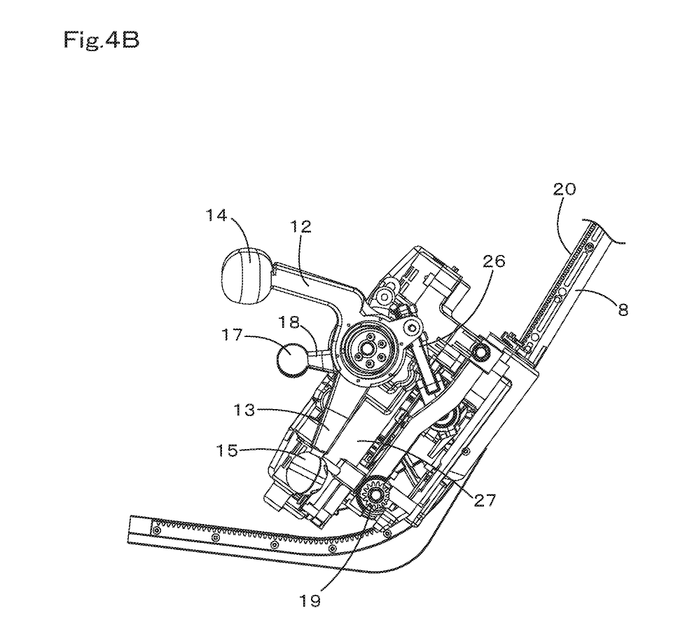

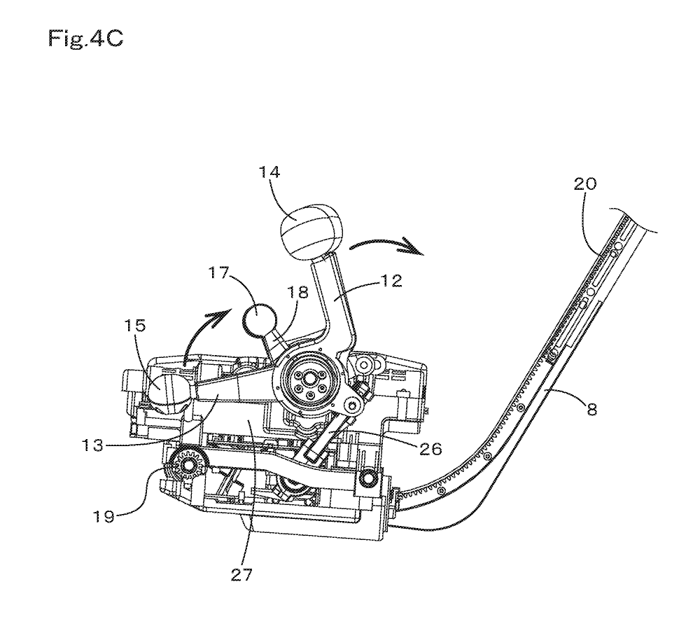

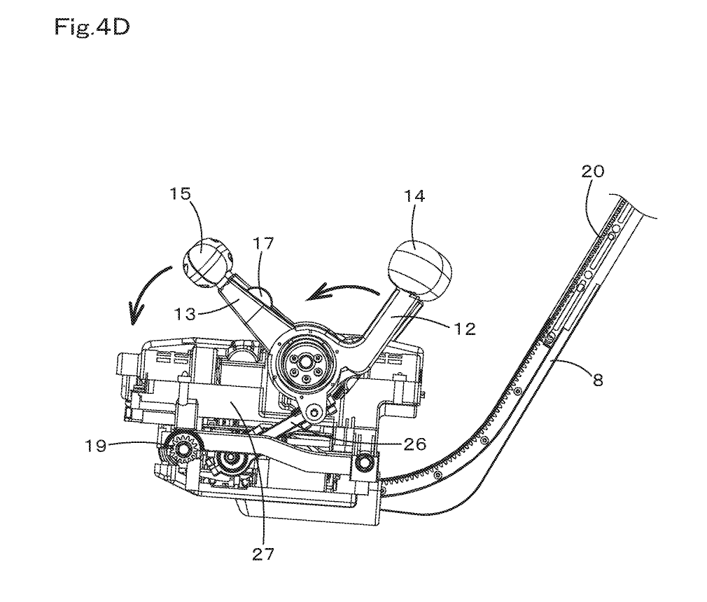

As shown in the drawing such as FIG. 3 or 4A, the described massaging mechanism 7 has the first arm 12 and the second arm 13 that advance toward a target of massage. The first massager piece 14 is attached to the tip of the first arm 12, and the second massager piece 15 is attached to the tip of the second arm 13. For example, given that a position with the massaging mechanism 7 at the top part of the moving rail 8 is defined as the reference, in this reference position, the first massager piece 14 lies at a point forwardly and upwardly of the massaging mechanism 7, and the second massager piece 15 lies at a point forwardly and downwardly of the massaging mechanism 7. The first arm 12 and the second arm 13 have a common base end (one and the same base end), and, the first arm 12 and the second arm 13 can be rocked unitarily on this common base end.

That is, a rotary shaft 18 is disposed so as to pass through the described base end common to the first and second arms 12 and 13 in the horizontal direction, and, the first arm 12 is disposed so as to extend radially outwardly with respect to the axis of the rotary shaft 18 as will hereafter be described, and the second arm 13, which is substantially perpendicular to the first arm 12, is disposed so as to extend radially outwardly from the base end. The base end of the first and second arms 12 and 13 is attached relatively to the described rotary shaft 18 for free rocking motion about an axis directed in the horizontal direction.

Moreover, in between the rotary shaft 18 and the base end of the first and second arms 12 and 13, there is provided the kneading massage means for transmitting the rotational motion of the rotary shaft 18 while converting it into rocking motion of the first arm 12 and the second arm 13 (motion conversion means). The kneading massage means will hereafter be described.

The first massager piece 14 and the second massager piece 15, which are brought into contact with a target of massage to produce massage effect, are each given a round form such as a ball form to avoid that the user feels a pain when the massager piece makes contact with the target of massage. More specifically, the tip of the first arm 12 is formed with a stem extending in a direction in which the first arm 12 extends, and, the first massager piece 14 is attached to the stem of the first arm 12 for free rotation about the axis of the stem of the first arm 12 (pointing in the extending direction of the first arm 12). Also, the tip of the second arm 13 is formed with a stem extending in a direction in which the second arm 13 extends, and, the second massager piece 15 is attached to the stem of the second arm 13 for free rotation about the axis of the stem of the second arm 13 (pointing in the extending direction of the second arm 13).

As shown in the drawings such as FIGS. 1, 2, and 4A to 4D, the moving rail 8, which is a rail for guiding the massaging mechanism 7 in vertical movement, is configured to cover a wide area of user's body, ranging downwardly from the shoulder to the buttocks. More specifically, the massaging mechanism 7 in this embodiment becomes movable when a pinion gear 19 disposed in the massaging mechanism 7 meshes with a toothed rack 20 of the moving rail 8. Moreover, in the moving rail 8 configured to cover the range from the shoulder to the buttocks, that side of it which faces a target of massage (front side or upper side of the moving rail 8) is formed with the toothed rack 20 which meshes with the pinion gear 19 of the vertically moving means.

The top and intermediate parts of the moving rail 8 in the vertical direction extend alongside a backrest surface 3a of the backrest portion 3, in other words, extend at an upward incline from the rear end of the seat portion 2 toward the rear, for guiding the massaging mechanism 7 toward a target of massage, such as the shoulder, the back, the waist, etc., of the user leaning against the backrest portion 3 so that the massager piece disposed in the massaging mechanism 7 is brought into contact with the target of massage. Moreover, the bottom part of the moving rail 8 in the vertical direction is disposed alongside a seat surface 2a of the seat portion 2 in the front-rear direction (horizontal direction), in other words, disposed substantially in parallel with the seat surface 2a, for bringing the massager piece into contact with user's buttocks as a target of massage. That is, the moving rail 8 is composed of the obliquely oriented intermediate part, the horizontally oriented bottom part, and an arcuately bent midportion acting as the connection between the intermediate part and the bottom part. That part of the moving rail 8 from the arcuately bent midportion upward (rear side) serves the range of massage including the shoulder, the back, and the waist, whereas that part of the moving rail 8 from the arcuately bent midportion downward (front side) serves the range of massage including the buttocks.

In the massage ranges defined by the moving rail 8 as above described, the massaging mechanism 7 performs massage with use of the massager piece jutting toward a target of massage while switching the massager piece to be jutted out between the first massager piece 14 and the second massager piece 15. Advancing and retracting movements of the first and second massager pieces 14 and 15 are effected by the jutting-amount varying means which will hereafter be described.

More specifically, as shown in FIG. 4A, when the massaging mechanism 7 is set in position in the massage range corresponding to the top part of the moving rail 8, the second massager piece 15 is moved in the opposite direction to a target of massage (moved backward) into a retracted position, and the first massager piece 14 is moved toward user's shoulder (moved forward). This forwardly jutting first massager piece 14 performs massage.

That is, under the condition shown in FIG. 4A, the first arm 12 is jutting forward, whereas the second arm 13 is in a retracted position while staying alongside the backrest surface 3a, as viewed from the massaging mechanism 7. Thus, the first massager piece 14 attached to the tip of the first arm 12 juts forward correspondingly, and is hence capable of massaging a target of massage such as the shoulder or the back.

Moreover, under the condition shown in FIG. 4A, the second massager piece 15 attached to the tip of the second arm 13 stays alongside the backrest surface 3a, and is hence clear of the described target of massage. Thus, even if the massaging mechanism 7 is moved in the vertical direction with the first massager piece 14 kept in contact with the target of massage, it never occurs that the movement of the massaging mechanism 7 is obstructed by the second massager piece 15.

By moving the massaging mechanism 7 in the position shown in FIG. 4A downward along the moving rail 8, the target body area to be massaged by the first massager piece 14 (target of massage) changes from the shoulder to the back, and from there down to other lower part. Then, when the massaging mechanism 7 reach a position as shown in FIG. 4B, the waist can be massaged as a new target of massage by the first massager piece 14.

Also under the condition shown in FIG. 4B where the waist can be massaged by the first massager piece 14, the first arm 12 is jutting forward, whereas the second arm 13 is in a retracted position while staying alongside the backrest surface 3a, as viewed from the massaging mechanism 7. Thus, the target waist can be massaged by the forwardly jutting first massager piece 14.

Thence, when the massaging mechanism 7 reaches a location ahead of the position shown in FIG. 4B in the moving rail 8, the described massage range changes from the shoulder-to-waist range to a buttocks range. In response to the change of the massage range, the massager piece for massaging a target of massage changes from the first massager piece 14 to the second massager piece 15.

More specifically, as shown in FIG. 4C, when the massaging mechanism 7 reaches the massage range corresponding to the bottom part of the moving rail 8, the first arm 12 and the second arm 13 are rocked backward (in the direction indicated by arrows shown in FIG. 4C) about the axis of the rotary shaft 18 at the base-end side, and the forwardly jutting first massager piece 14 is retracted. At the same time, the second massager piece 15, which is now laid alongside the backrest surface 3a, is rocked backward into an upwardly jutting position.

In consequence, as shown in FIG. 4D, the upwardly jutting second massager piece 15 can be brought into contact with the buttocks, thus performing massage on the buttocks by the second massager piece 15.

Although the described operation of the massaging mechanism 7 corresponds to the downward movement along the moving rail 8, similar operation is effected during the upward movement of the massaging mechanism 7 along the moving rail 8. That is, when the massaging mechanism 7 is moved along the moving rail 8 to change its position from the lower (frontward) massage range to the upper (rearward) massage range, then the first arm 12 and the second arm 13 are rocked forward (in the direction indicated by arrows shown in FIG. 4D) about the axis of the rotary shaft 18 at the base-end side, and the upwardly jutting second massager piece 15 is retracted, whereas the downwardly retracted first massager piece 14 is actuated to jut upward.

As described above, during its movement along the moving rail 8, the massaging mechanism 7 performs massage with use of the massager piece in a jutting-out condition while switching the massager piece to be jutted out between the first massager piece 14 and the second massager piece 15. This is of advantage in the case of massaging the target buttocks.

That is, in the massaging mechanism 7 set in position at the bottom part of the moving rail 8, the second arm 13 is directed forwardly and upwardly, so that the buttocks can be massaged by the second massager piece 15 attached to the tip of the second arm 13. In this case, the forward reach of the second massager piece 15 can be increased by an amount equivalent to the length of the second arm 13. In other words, even if the length of the moving rail 8 is reduced by an amount equivalent to the length of the second arm 13, it is possible to perform massage on the buttocks. Thus, even if the lower end of the moving rail 8 lies behind the buttocks, expressed differently, even if the moving rail 8 has a shorter length, the massager piece can be brought into contact with the buttocks to perform massage without fail.

Moreover, such a construction makes it possible to eliminate the need for the moving rail 8 to be long in the front-rear direction, and thereby simplify the apparatus structure and hence reduce manufacturing costs. For example, as shown in FIG. 2, even if the lower end of the moving rail 8 lies behind the center of the seat portion 2 in the front-rear direction, the massaging mechanism 7 is capable of massaging the buttocks without fail.

In addition, in the described construction, since the length of the moving rail 8 can be reduced, it is possible to leave a space for housing the footrest portion 5 under the front side of the seat portion 2 (a space which constitutes the housing chamber 11) correspondingly, and thereby impart a buttock-massaging function even to a chair massager 1 of a type in which the footrest portion 5 is housed under the seat portion 2.

It is preferable that the second arm 13 is made relatively long compared to the first arm 12 and the grabbing arm 16 of the grabbing massage means in the interest of bringing the second massager piece 15 into contact with the buttocks lying further ahead of the lower end (lower terminal end) of the moving rail 8. In the case where the second arm 13 is greater in length than the first arm 12, by moving the second arm 13 forward while retracting the first arm 12, it is possible to direct the second arm 13 to a location further ahead of the moving rail 8 beyond the first arm 12, and thereby bring the second massager piece 15 into contact with the buttocks even if the moving rail 8 has a shorter length. Moreover, in the case where the second arm 13 is greater in length than the grabbing arm 16, when the second arm 13 juts forward (juts toward the seat portion), it is possible to avoid that the weight of the user is applied to the grabbing massager piece 17, and thereby prevent damage to the grabbing massager piece 17 which is intended for grabbing and kneading massage and is hence not adapted to receive a heavy load.

It is essential only that the chair massager 1 pursuant to the present invention comprise the moving rail 8 and the massaging mechanism 7 thus far described, wherefore the vertically moving means, the kneading massage means, the grabbing massage means, and the jutting-amount varying means are not limited to any particular structures.

The following describes preferred configurations of the vertically moving means, the kneading massage means, the grabbing massage means, and the jutting-amount varying means adopted by the applicants of the present application.

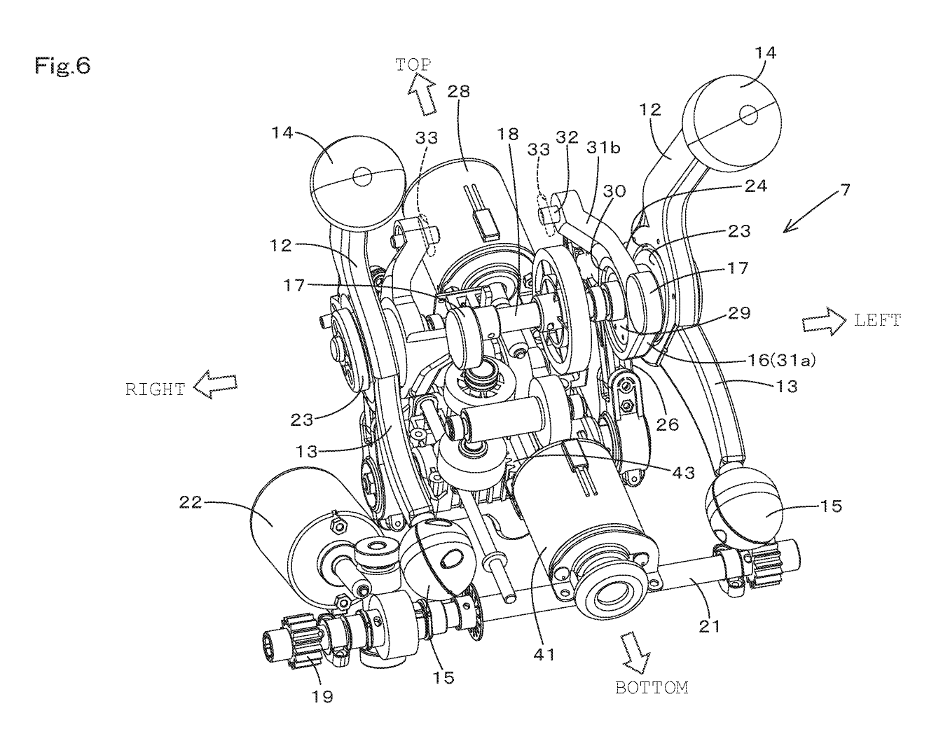

In the following description, the position with the massaging mechanism 7 at the top part of the moving rail 8 is defined as the reference, and, with use of directions defined on the basis of the massaging mechanism 7 in this reference position, the massaging mechanism 7 and the internal structure of the massaging mechanism 7 will be described. Each direction is indicated by corresponding one of the arrows shown in FIGS. 6 to 9.

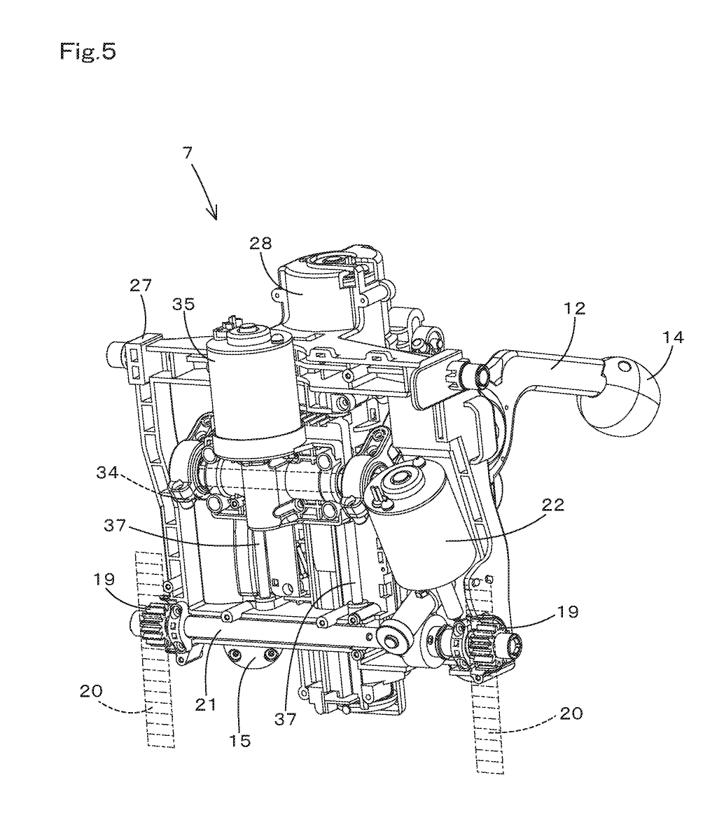

To begin with, as shown in the drawing such as FIG. 5, the vertically moving means comprises: the pinion gear 19 disposed on the side opposite to the target-facing side of the massaging mechanism 7 so as to mesh with the toothed rack 20 of the moving rail 8; an up-and-down shaft 21 fitted at each end with the pinion gear 19, which is free to rotate about a horizontally-directed axis; and an up-and-down drive section 22 (up-and-down motor) for rotatably driving the up-and-down shaft 21. That is, in the vertically moving means, the pinion gear 19 of the up-and-down shaft 21 rotatably driven by the up-and-down drive section 22 meshes with the toothed rack 20 of the moving rail 8, thus moving the massaging mechanism 7 fitted with the up-and-down shaft 21 along the direction of arrangement of the moving rail 8. In this embodiment, the toothed rack 20 is provided in each of the right and left moving rails 8, and, the pinion gear 19 disposed at each end of the up-and-down shaft 21 meshes with the corresponding toothed rack 20. However, a construction provided with a single toothed rack 20 and a single pinion gear 19 may be adopted instead.

As shown in FIG. 6, the kneading massage means rocks the first arm 12 and the second arm 13 so that they move close to and away from each other in the horizontal direction, thus holding in sandwich relation a target area of user's body between the first massager pieces 14, or between the second massager pieces 15, for performing kneading massage on the target of massage.

More specifically, the kneading massage means comprises: the rotary shaft 18 whose axis is directed in the horizontal direction; and a pair of right and left substantially cylindrical inclined boss portions 23 disposed on a lengthwise intermediate part of the rotary shaft 18 for unitary rotation with the rotary shaft 18. The outer peripheral surface of the inclined boss portion 23 is formed with an inclined cam face which goes around an axis intersected by the axis of the rotary shaft 18. A first annular fit portion 24 attached to the base end of the first and second arms 12 and 13 is fitted to (fitted onto) the outer periphery of the inclined boss portion 23. The first annular fit portion 24, which is a ring-shaped member having a centrally located opening pointing in the horizontal direction, is externally engageable with the inclined cam face. That is, the first annular fit portion 24 is fitted so as to be slidable along the inclined cam face, thus enabling each of the described first and second arms 12 and 13 to rotate (rock) freely about the rotary shaft 18.

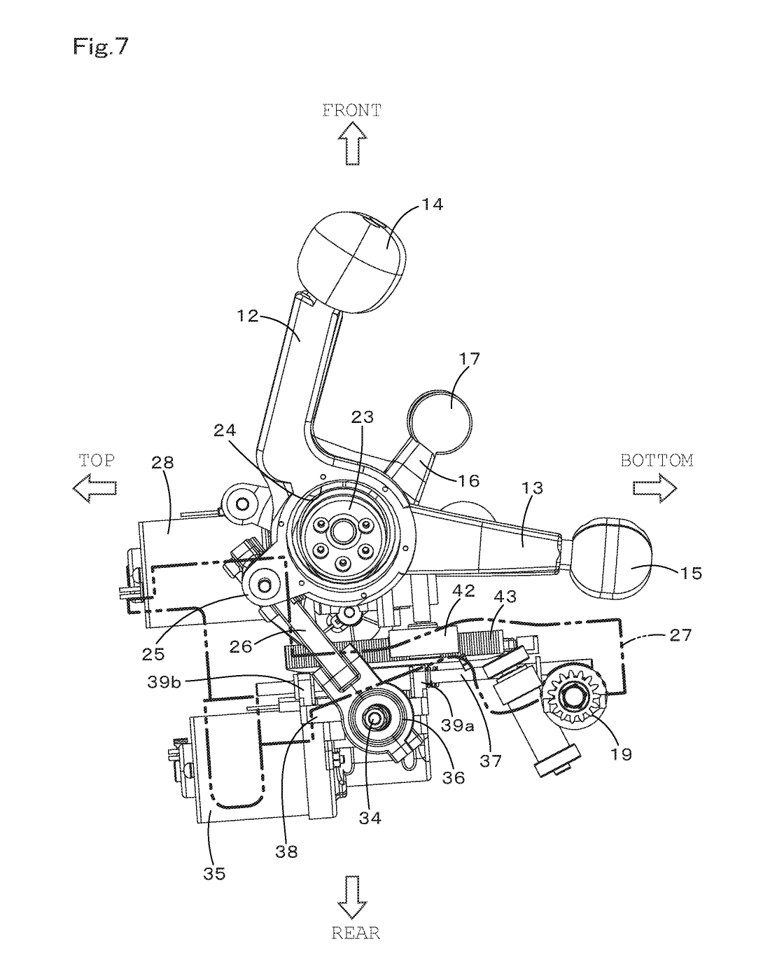

Moreover, as shown in FIG. 7, the base end of the first and second arms 12 and 13 is formed with a projected piece 25 protruding opposite to the extending direction of the first and second arms 12 and 13. The tip of the projected piece 25 is coupled with a coupling shaft 26. The coupling shaft 26 couples the base end of the first and second arms 12 and 13 to a base stand 27 (which is a member equivalent to a casing of the massaging mechanism 7 indicated by a virtual line in FIG. 7) for restraining the base end of the first and second arms 12 and 13 from rotating unitarily with the inclined boss portion 23. Moreover, on the front side of the massaging mechanism 7 is disposed a kneading drive motor 28 in a drive shaft-downward fashion for rotatably driving the described rotary shaft 18. A rotational driving force produced by the kneading drive motor 28 is transmitted to the rotary shaft 18, thus driving the rotary shaft 18 to rotate about a horizontally-directed axis.

That is, in the kneading massage means, under the transmission of the rotational driving force produced by the kneading drive motor 28, the rotary shaft 18 is rotated about the horizontally-directed axis, and correspondingly the inclined boss portion 23 mounted for unitary rotation with the rotary shaft 18 is rotated. Then, the base end of the first and second arms 12 and 13 seeks to rotate unitarily with the inclined boss portion 23 along the inclined cam face which is going around the axis intersected by the axis of the rotary shaft 18. However, since the base end of the first and second arms 12 and 13 is secured to the base stand 27 by the described coupling shaft 26, it never occurs that the base end of the first and second arms 12 and 13 rotates unitarily with the inclined boss portion 23. Consequently, the first arm 12 and the second arm 13 are rocked horizontally reciprocally over and over again while being restrained from rotation about the axis of the rotary shaft 18, and correspondingly the first massager piece 14 and the second massager piece 15 attached to the tips of the first arm 12 and the second arm 13, respectively, are rocked horizontally, thus holding in sandwich relation a target of massage between these massager pieces for performing kneading massage on the target of massage.

The grabbing massage means has the grabbing arm 16 which, like the described first and second arms 12 and 13, advances toward a target of massage, and the grabbing massager piece 17 attached to the tip of the grabbing arm 16.

The grabbing arm 16 is disposed on the rotary shaft 18 so as to be located inwardly from the base end of the first and second arms 12 and 13 in the direction of the width of the rotary shaft 18 in contiguous relation to the inclined boss portion 23.

More specifically, the grabbing massage means has an eccentric boss portion 29 which is, like the inclined boss portion 23, able to rotate unitarily with the rotary shaft 18. The outer peripheral surface of the eccentric boss portion 29 is formed with an eccentric cam face having a go-around trackway which is eccentric with respect to the axis of the rotary shaft 18. In response to the rotation of the rotary shaft 18, the eccentric cam face follows the go-around trackway which is eccentric with respect to the axis of the rotary shaft 18. Moreover, as with the inclined boss portion 23, a second annular fit portion 30 in ring-like form is fitted externally to the eccentric cam face of the eccentric boss portion 29 for free sliding movement along the eccentric cam face. The second annular fit portion 30 is located at the base end of the grabbing arm 16.

The grabbing arm 16 has two projections 31 arranged so as to extend radially outwardly with respect to its base end rotatably coupled to the rotary shaft 18 (extend in a direction away from the axis of the rotary shaft 18) in substantially perpendicular relation to each other. One of the two projections 31a and 31b, namely the projection 31a (lower projection as seen in FIG. 6) is fitted at its tip with the described grabbing massager piece 17. Moreover, the tip of the other projection 31b (upper projection as seen in FIG. 6) is formed with a restraint pin 32 extending inwardly in the width direction for controlling the direction of rocking motion of the grabbing arm 16. The restraint pin 32 is fitted in a restraint slot 33 formed in, for example, the cover of the backrest portion 3 (indicated by a dotted line shown in FIG. 6). Moreover, the restraint slot 33 is formed so as to extend in a direction which is substantially parallel to the described moving rail 8, or equivalently the vertical direction, for guiding the restraint pin 32 in movement along the direction of slotting the restraint slot 33.

Thus, upon rotating the rotary shaft 18 by using the kneading drive section (kneading drive motor 28), the base end of the grabbing arm 16 seeks to rotate eccentrically about the axis of the rotary shaft 18 along the eccentric cam face which is going eccentrically around the axis of the rotary shaft 18. At this time, however, since the restraint pin 32 of the projection 31 provided in the grabbing arm 16 fits in the restraint slot 33, it never occurs that the grabbing arm 16 rotates unitarily with the eccentric boss portion 29. Moreover, the restraint pin 32, fitting in the restraint slot 33, is allowed to move only in the vertical direction, wherefore the grabbing massager piece 17-bearing tip of the projection 31 of the grabbing arm 16 is reciprocated in the front-rear direction over and over again. Thus, the first massager piece 14 of the now horizontally rocking first arm 12 undergoes approaching and separating movements relative to the grabbing massager piece 17 reciprocating in the front-rear direction, thus holding in sandwich relation a target of massage between the grabbing massager piece 17 and the first massager piece 14 for performing grabbing massage on the target of massage.

As contrasted to the embodiment thus far described, the restraint slot 33 may be formed in the grabbing arm 16. In this case, the restraint pin 3 is fixedly positioned in face-to-face relation to the restraint slot 33 (formed inside the cover, for example). That is, the restraint pin 32 and the restraint slot 33 may be arranged in the place of each other.

Moreover, the member indicated by the numeral 32 does not necessarily have to have the form of a pin (rodlike form), and needs only be configured to be engageable with the member indicated by the numeral 33 for preventing the grabbing arm 16 from rotating together with the rotary shaft 18.

As shown in FIG. 7, the base end of the first and second arms 12 and 13 is formed with the projected piece 25 protruding opposite to the extending direction of the first massager piece 14 and the second massager piece 15. The described coupling shaft 26 is coupled to the tip of the projected piece 25. The coupling shaft 26 is mounted for free axial rocking motion with respect to a horizontally-directed axis relative to the tip of the projected piece 25 by a ball bearing system. Moreover, an end of the coupling shaft 26 opposite to the projected piece 25-side end is coupled to a tapping drive shaft 34 attached to the base stand 27 of the massaging mechanism 7, or more specifically the rear side of the massaging mechanism 7.

More specifically, like the rotary shaft 18, the tapping drive shaft 34 is a shaft pointing in the horizontal direction that is rotatably driven by a tapping drive motor 35 mounted at the rear of the massaging mechanism 7. A cylindrical tapping boss portion 36 is attached to each end of the horizontally-elongated tapping drive shaft 34 in eccentric relation to the axis of the tapping drive shaft 34. In response to the rotation of the tapping drive shaft 34, the tapping boss portion 36 undergoes eccentric rotation. The end of the coupling shaft 26 is rotatably fitted loosely to the outer peripheral surface of the tapping boss portion 36 for vertical rocking motion.

That is, upon rotating the tapping drive shaft 34 by the tapping drive motor 35, the tapping boss portion 36 eccentrically attached to the tapping drive shaft 34 undergoes eccentric rotation about the axis of the tapping drive shaft 34. Likewise, the end of the coupling shaft 26 also undergoes eccentric rotation. In sync with the eccentric rotation of the end of the coupling shaft 26, the base end of the first and second arms 12 and 13 does a repeat of a cycle of normal rotation and reverse rotation about the axis of the rotary shaft 18, thus alternately pressing the first massager piece 14 attached to the tip of the first arm 12 and the second massager piece 15 attached to the tip of the second arm 13 hard against a target of massage for performing tapping massage on the target of massage.

The jutting-amount varying means is intended to actuate one of the first massager piece 14 and the second massager piece 15 to jut toward a target of massage (move forward), while switching the massager piece for massaging a target of massage between the first massager piece 14 and the second massager piece 15.

The jutting-amount varying means has a rodlike guide section 37 disposed toward the base stand 27 in parallel with the direction of arrangement of the moving rail 8. There are provided two guide sections 37 disposed one at each of the right and left sides of the massaging mechanism 7 in a parallel arrangement. Both ends of each guide section 37 are secured to the base stand 27. The guide section 37 is provided intermediate its lengthwise ends with a guide 38 mounted for free movement along the direction of arrangement of the guide section 37.

More specifically, the guide 38 is a platy member disposed so as to span the paired right and left guide sections 37. The surface of that part of the guide 38 located toward the guide section 37 is provided with a restraining portion 39 having an insertion hole for receiving the guide section 37. There are provided two spaced apart restraining portions 39 for a single guide section 37, or a total of four restraining portions 39 in all arranged in spanning relation to the two guide sections 37. The guide 38 is guided in free movement along the direction of arrangement of the guide section 37 (vertical direction) via the four restraining portions 39.

Moreover, in a region between the two restraining portions 39 in the guide section 37, there is provided a slide 40 which is smaller in length than the region between the restraining portions 39 and is movable along the guide section 37 within the region between the restraining portions 39. The slide 40 can be moved by exploiting a rotational driving force exerted by an arm jutting motor 41.

More specifically, the arm jutting motor 41 is mounted, with its drive shaft directed in the front-rear direction, for rotating a second pinion gear 42 whose axis is directed in the front-rear direction. The second pinion gear 42 has a meshing engagement with a second toothed rack 43 pointing in the vertical direction in parallel with the moving rail 8. Upon rotating the second pinion gear 42, the second toothed rack 43 in meshing engagement with the second pinion gear 42 is moved in a direction parallel to the moving rail 8. The second toothed rack 43 and the described slide 40 are secured to each other for unitary movement. Thus, by driving the arm jutting motor 41, it is possible to move the slide 40 in the direction parallel to the moving rail 8.

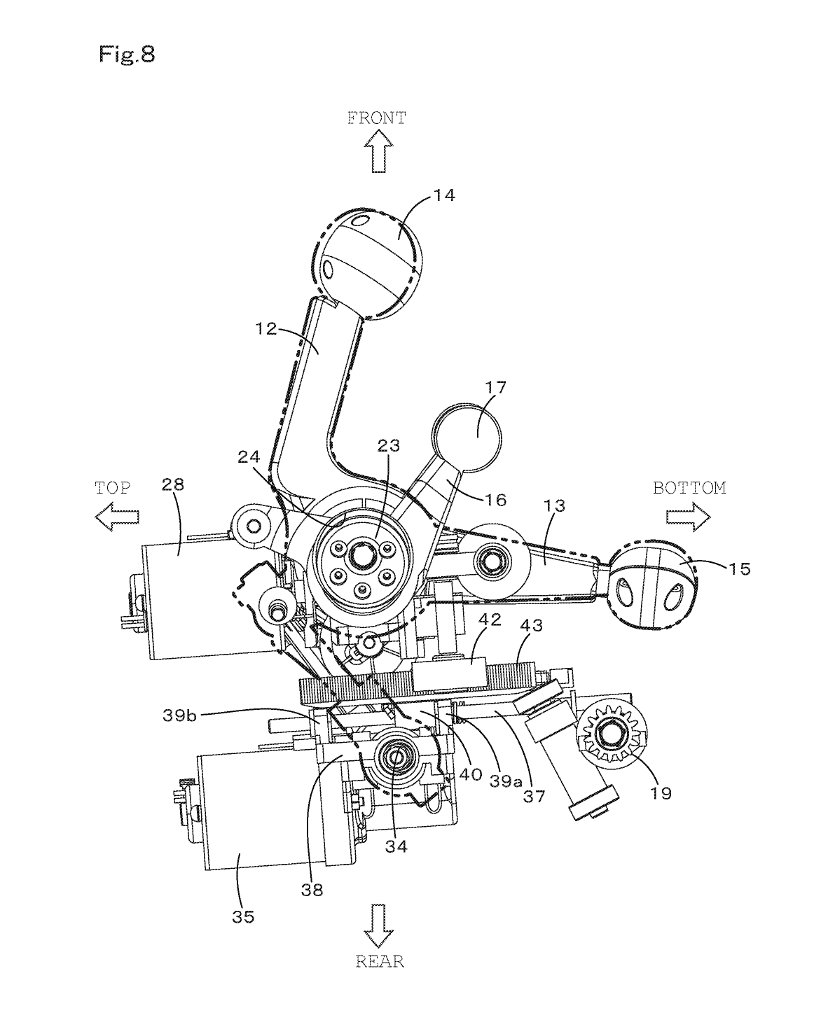

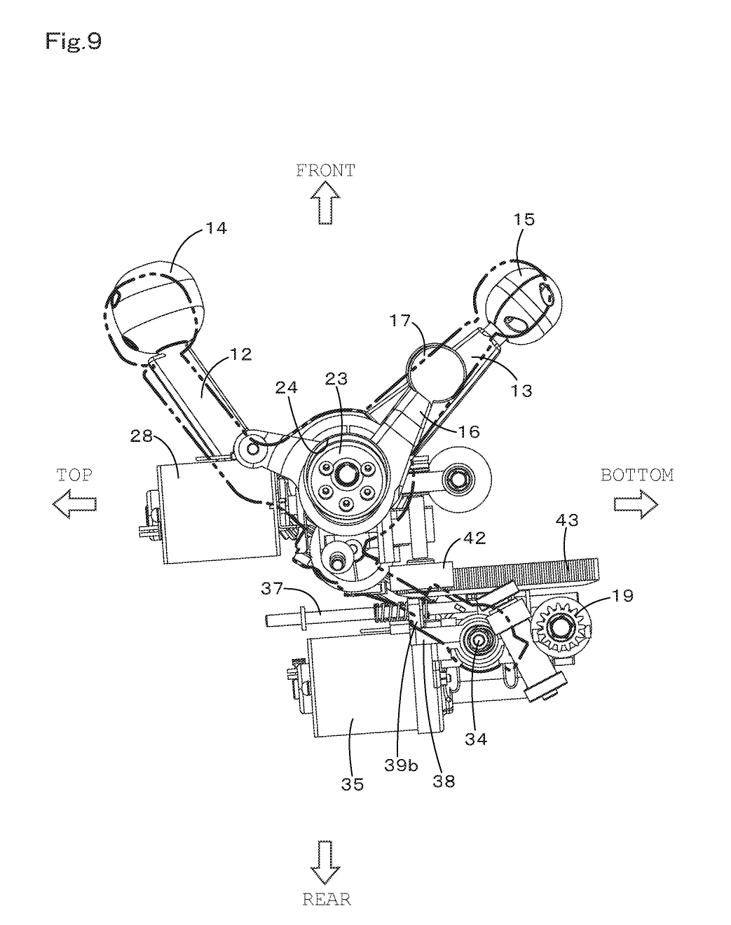

For example, as shown in FIG. 8, before long after being moved downward in the direction parallel to the moving rail 8, the slide 40 abuts on the lower one of the described two restraining portions 39 (first restraining portion 39a). Then, the guide 38 and the slide 40 are unitarily moved downward along the guide section 37. In consequence, the position of the end of the coupling shaft 26 (the end fitted with the tapping boss portion 36) is lowered, wherefore the base end of the first and second arms 12 and 13 is rocked downward about the axis of the rotary shaft 18 under the pull of the coupling shaft 26. Then, as shown in FIG. 9, the tip of the first arm 12 is rocked downward with respect to the base end, thus causing the first massager piece 14 attached to the tip of the first arm 12 to retract backward. Moreover, the tip of the second arm 13 is rocked downward with respect to the base end, thus causing the second massager piece 15 attached to the tip of the second arm 13 to jut forward. In this way, as a target of massage, the buttocks can be massaged by the forwardly jutting second massager piece 15 (lower kneading ball).

On the other hand, when the arm jutting motor 41 is operated to turn in a direction opposite to that which has just been described, before long after being moved upward in the direction parallel to the moving rail 8, the slide abuts on the upper one of the described two restraining portions 39 (second restraining portion 39b). Then, the guide 38 and the slide 40 are unitarily moved upward along the guide section 37. In consequence, the position of the end of the coupling shaft 26 (the end fitted with the tapping boss portion 36) is raised, wherefore the base end of the first and second arms 12 and 13 is rocked upward about the axis of the rotary shaft 18 under the pull of the coupling shaft 26. Then, as shown in FIG. 8, the second massager piece 15 attached to the tip of the second arm 13 is retracted, and the first massager piece 14 attached to the tip of the first arm 12 juts forward. In this way, as targets of massage, the shoulder, the back, and the waist can be massaged by the forwardly jutting first massager piece 14 (upper kneading ball).

By actuating the second arm 13 to jut toward a target of massage instead of the first arm 12, it is possible to increase the forward reach of the second massager piece 15 by an amount equivalent to the length of the second arm 13. Thus, even with use of a short moving rail 8 which terminates at a position on the rear side of the seat portion 2, as a target of massage, user's buttocks can be massaged without fail.

That is, in the chair massager 1 in this embodiment, the lower one of the described two restraining portions 39 serves as the first restraining portion 39a for maintaining a rocking angle of the second arm 13 for a fully forwardly jutting-out position of the second arm 13, and, the upper restraining portion 39 serves as the second restraining portion 39b for maintaining a rocking angle of the first arm 12 for a fully jutting-out position of the first arm 12. Moreover, the spacing between the first restraining portion 39a and the second restraining portion 39b serves as a non-restraining portion for permitting rocking motion of the base end of the first and second arms 12 and 13 about the axis of the rotary shaft 18.

It should be understood that each embodiment as disclosed hereinabove is considered in all respects as illustrative only and not restrictive. As to particulars that are not explicitly specified in each embodiment as disclosed hereinabove, for example, working conditions, operation procedures, various parameters, and the dimensions, weights, and volumes of constituent components in particular, values that do not depart from the scope of the present invention to be fulfilled by those skilled in the art and are easily conceivable by persons having ordinary skill in the art are assigned to those particulars.

For example, in this description, the chair massager exemplifies the application of the present invention. However, the massaging mechanism 7 may also be installed in a seat massager, a legless chair massager, and a hand-held massager.

### EXPLANATION OF REFERENCE SYMBOLS

1 Chair massager
2 Seat portion
2a Seat surface
3 Backrest portion
3a Backrest surface
4 Armrest portion
5 Footrest portion
6 Support frame
7 Massaging mechanism
8 Moving rail
9 Floor-mounted frame
10 Leg insertion recess
11 Housing chamber
12 First arm
13 Second arm
14 First massager piece
15 Second massager piece
16 Grabbing arm
17 Grabbing massager piece
18 Rotary shaft
19 Pinion gear
20 Toothed rack
21 Up-and-down shaft
22 Up-and-down drive section (Up-and-down motor)
23 Inclined boss portion
24 First annular fit portion
25 Projected piece
26 Coupling shaft
27 Base stand
28 Kneading drive motor
29 Eccentric boss portion
30 Second annular fit portion
31 Projection
31a Lower projection
31b Upper projection
32 Restraint pin
33 Restraint slot
34 Tapping drive shaft
35 Tapping drive motor
36 Tapping boss portion
37 Guide section
38 Guide
39 Restraining portion
39a First restraining portion
39b Second restraining portion
40 Slide
41 Arm jutting motor
42 Second pinion gear
43 Second toothed rack

1. A chair massager comprising:
a massaging mechanism having a massager piece for massaging a body part of a user to be massaged as a target of massage; and
a moving rail disposed along a vertical direction to guide said massaging mechanism in movement in the vertical direction,
said massager piece including a first massager piece lying in an upper position as seen from said massaging mechanism, and a second massager piece lying in a lower position as seen from said massaging mechanism,
said massaging mechanism being designed to perform massage by actuating said second massager piece to jut toward the target of massage when the massaging mechanism is set in position at a bottom part of said moving rail.

2. The chair massager according to claim 1,
wherein said massaging mechanism is designed to perform massage by actuating said first massager piece to jut toward user's shoulder, while retracting said second massager piece, when said massaging mechanism is set in position at a top part of said moving rail, as well as to perform massage by actuating said second massager piece to jut toward user's buttocks, while retracting said first massager piece, when said massaging mechanism is set in position at the bottom part of said moving rail.

3. The chair massager according to claim 2, further comprising:
a seat portion in which said user sits; and
a backrest portion for supporting the back of the user sitting in said seat portion,
wherein the top part of said moving rail is disposed inside said backrest portion so as to point in the vertical direction alongside a backrest surface of said backrest portion,
wherein the bottom part of said moving rail is disposed alongside a seat surface of said seat portion,
and wherein a lower end of said moving rail is situated below said seat portion.

4. The chair massager according to claim 3,
wherein said massaging mechanism has a first arm and a second arm that extend upwardly and downwardly, respectively, as viewed from the massaging mechanism set in position at the top part of said moving rail,
and wherein the first massager piece is attached to a tip of said first arm, and the second massager piece is attached to a tip of said second arm.

5. The chair massager according to claim 4,
wherein said second arm is made relatively long compared to said first arm.

6. The chair massager according to claim 4,
wherein said first massager piece is mounted for free rotation relative to said first arm, and, said first massager piece is brought into contact with the shoulder, with its axis of rotation directed in a direction intersected by the top part of said moving rail,
and wherein said second massager piece is mounted for free rotation relative to said second arm, and, said second massager piece is brought into contact with the buttocks, with its axis of rotation directed in a direction which is substantially parallel to the bottom part of said moving rail.

7. The chair massager according to any one of claims 4 to 6,
wherein said first arm and said second arm are joined together at one and the same base end, and this base end is pivotally mounted for free rocking motion upon a rotary shaft whose axis is directed in a horizontal direction,
wherein there is provided jutting-amount varying means for varying an amount of jutting motion of said first arm and said second arm facing toward said target of massage by rocking the base end of said first and second arms about said rotary shaft,
wherein said jutting-amount varying means comprises:
a guide, secured to a tapping drive section, having two restraining portions arranged in a predetermined spacing;
a coupling shaft for coupling the base end of said first and second arms to said guide; and
a slide which is smaller in length than the predetermined spacing in said guide, and is driven to move within a range of the spacing,
wherein one of the restraining portions formed in said guide is defined as a first restraining portion, and the other is defined as a second restraining portion, and, the spacing between the first restraining portion and the second restraining portion serves as a non-restraining portion,
wherein the first restraining portion of said jutting-amount varying means maintains a rocking angle of said first arm or said second arm for a fully jutting-out position of the first arm or the second arm, and, the second restraining portion of said jutting-amount varying means maintains a rocking angle of said second arm or said first arm for a fully jutting-out position of the second arm or the first arm,
and wherein the non-restraining portion of said jutting-amount varying means permits axial rocking motion of the base end of said first and second arms within a range of the spacing between the first restraining portion and the second restraining portion.

8. The chair massager according to claim 7, further comprising:
a grabbing massager piece which performs grabbing massage on said target of massage during its approaching and separating movements relative to said first massager piece; and
a grabbing arm provided at its tip with said grabbing massager piece.

9. The chair massager according to claim 8,
wherein, while said grabbing massager piece stays in proximity to the first massager piece, said first massager piece can be rocked in the horizontal direction.

10. The chair massager according to claim 9,
wherein said second arm is made relatively long compared to said grabbing arm.

11. A massaging mechanism having a grabbing arm provided at its one side with a grabbing massager piece and a first arm provided at its tip with a first massager piece, for producing massaging action by actuating said grabbing arm and said first arm,
said massaging mechanism being designed to actuate said grabbing arm so that said grabbing massager piece moves close to and away from the first massager piece.

12. The massaging mechanism according to claim 11, further comprising:
an eccentric boss portion, mounted eccentrically with respect to a rotary shaft, having a cam face formed on its outer peripheral surface;
an annular fit portion attached to said grabbing arm so as to engage with the cam face of said eccentric boss portion; and
a restraint section for restraining said grabbing arm from rotating together with said rotary shaft in response to a rotation of the rotary shaft.

13. The massaging mechanism according to claim 12,
wherein said restraint section includes a restraint pin attached to the other side of said grabbing arm, and a restraint slot located in face-to-face relation to said restraint pin, in which the restraint pin is slidably fitted.

14. The massaging mechanism according to claim 12,
wherein said restraint section includes a restraint slot formed in the other side of said grabbing arm, and a restraint pin, disposed in face-to-face relation to said restraint slot, which fits in the restraint slot for free sliding movement.

15. The massaging mechanism according to any one of claims 11 to 14,
wherein said first arm is provided at its tip with the first massager piece, and, the rotary shaft is disposed so as to pass through an intermediate part or a base end of the first arm,
and wherein said first arm is driven to rock in the horizontal direction under a driving force exerted by said rotary shaft.
